(19) United States
(12) Patent Application Publication
(10) Pub. No.: US 2023/0383465 A1
(43) Pub. Date: Nov. 30, 2023

(54) Filter For Smoking or Vaping Article Comprising a Smooth Paper

(71) Applicant: Mativ Holdings, Inc., Alpharetta, GA (US)

(72) Inventors: Diane Raverdy-Lambert, Le Mans (FR); Patrick Guilchet, Spay (FR)

(21) Appl. No.: 18/318,271

(22) Filed: May 16, 2023

(30) Foreign Application Priority Data
May 25, 2022 (FR) 2205023

(51) Int. Cl. D21G 1/02; D21H 11/00; A24D 3/10; A24D 3/06; A24D 3/17

(52) U.S. Cl. CPC D21G 1/0233; D21H 11/00; D21G 1/0253; D21G 1/0246; A24D 3/10; A24D 3/063; A24D 3/17

(57) ABSTRACT

The present invention relates to a paper substrate with smooth face that is suitable for being used in a filter for a smoking article or vaping article.

### TECHNICAL FIELD

The invention provides a smooth paper substrate. This material can be used in a filter for a smoking or vaping article.

### PRIOR ART

A filter for a smoking or vaping article has a right circular cylindrical shape and generally comprises an outer envelope of plug wrap paper and a substrate located within the outer envelope. The filter for a smoking or vaping article, by virtue of the substrate, makes it possible to prevent the user from inhaling tobacco particles and allows retention of the harmful particulate substances contained in the smoke or the aerosol, such as tar.

Conventional filters are made from cellulose acetate. These conventional filters have a nicotine retention capacity such that the user's perception of the filtered smoke is satisfactory. In addition, these conventional filters generate a filtered smoke having good organoleptic properties. However, conventional filters degrade extremely slowly, are not rapidly dispersible in water and generate microplastics which accumulate and enter the food chain. This is particularly harmful since the filter is not consumed during the smoking/vaping of a smoking or vaping article and is regularly found in the environment. Conventional filters thus have a significant environmental impact.

To limit the environmental impact of conventional filters, it has been proposed to replace the cellulose acetate with a paper substrate obtained by a wetlaid process. As these paper substrates are biodegradable, they degrade rapidly. However, the capacity for retention of the particulate phase of the aerosol, in particular of the nicotine, of filters comprising a paper substrate is greater than the capacity for retention of the particulate phase of conventional filters. Thus, the user's perception of the smoke filtered by filters comprising a paper substrate may not be satisfactory. For example, the smoke filtered by filters comprising a paper substrate may have a bland taste. The user experience provided by these paper substrates is thus not as satisfactory when compared with the filters made from cellulose acetate.

### Technical Problem

There is therefore a need for a filter comprising a paper substrate which has a nicotine retention capacity that is closer to, or even of the same order of magnitude as, the retention capacity of a filter comprising a cellulose acetate substrate, and which thus provides a satisfactory user experience.

It is thus to the credit of the inventors to have found that it was possible to meet this need by means of a smooth paper substrate.

### SUMMARY

According to one aspect, the invention proposes a paper substrate comprising two faces, one of the two faces, in particular both faces, having a smoothness greater than or equal to 20 s, in particular between 20 s and 600 s, very particularly between 30 s and 500 s, more particularly from 40 s to 400 s, and even more particularly between 50 s and 300 s.

In a filter, the paper substrate of the invention is used as the filtration material. Advantageously, the filtration properties of the filter comprising the paper substrate of the invention are better than the filtration properties of a filter comprising a conventional paper substrate. Indeed, the difference between the nicotine retention capacity of a filter comprising the paper substrate according to the invention and the nicotine retention capacity of a cellulose acetate filter is smaller than the difference between the nicotine retention capacity of a filter comprising a conventional filtration paper substrate and the nicotine retention capacity of a cellulose acetate filter.

Consequently, the users perception of the smoke filtered by a filter comprising the paper substrate according to the invention is more satisfactory than the users perception of the smoke filtered by a filter comprising a conventional paper substrate.

Without wishing to be bound by any theory, the inventors are of the opinion that the filtration properties of a filter comprising the paper substrate of the invention are better than the filtration properties of a filter comprising a conventional paper substrate because the smoothness of one of the two faces, in particular of both faces, of the paper substrate of the invention is greater than the smoothness of the two faces of the conventional paper substrates.

The smoothness of a paper substrate is characteristic of the number of fibrils projecting upright or semi-upright at the surface of this paper substrate. By increasing the smoothness of one of the two faces, in particular of both faces, of the paper substrate of the invention, i.e. by reducing the number of fibrils projecting upright or semi-upright at the surface of the paper substrate of the invention, the inventors have followed an approach that goes against the conventional approach, and have obtained an unexpected result.

This is because, in order to not impact negatively the filtration properties of the filters by reducing the permeability of the paper substrates, paper substrates of filters are conventionally obtained from unrefined fibres such that the smoothness of the faces of the conventional paper substrates is low, i.e. less than 10 s.

In addition, in contrast to a cellulose acetate filter, the paper substrate according to the invention may, by virtue of its composition, degrade very rapidly in the environment. This is particularly advantageous, since the environmental impact of the filter comprising the paper substrate according to the invention is smaller than the environmental impact of a cellulose acetate filter.

According to another aspect, the invention proposes a process for producing the paper substrate according to the invention, comprising the following steps:
a) producing a rough-faced paper substrate by a wetlaid process,
b) smoothing the rough-faced paper substrate which is produced in step a) to produce the paper substrate,
wherein smoothing step b) is carried out by calendering, flint glazing and combinations thereof, in particular by calendering.

### DESCRIPTION OF THE EMBODIMENTS

According to one aspect, the invention proposes a paper substrate comprising two faces, one of the two faces, in particular both faces, having a smoothness greater than or equal to 20 s, in particular between 20 s and 600 s, very particularly between 30 s and 500 s, more particularly from 40 s to 400 s, and even more particularly between 50 s and 300 s.

For the purposes of the present application, “paper substrate” denotes a sheet consisting of cellulosic fibres obtained by a wetlaid process and comprising two faces, a front face and a back face. A substrate obtained by a drylaid process or by an airlaid process is not a paper substrate within the meaning of the present application.

For the purposes of the present invention, “smoothness” denotes the time, in seconds, which, under a determined pressure difference, is required to suck a certain amount of air at atmospheric pressure between the face of a test specimen of the paper substrate and a plane in the form of a ring, under determined conditions of contact. The higher the smoothness of a face of the paper substrate, the smoother the face of the paper substrate. The smoothness can be determined via the standard ISO 5627:1995 on one or both faces of the paper substrate.

The cellulosic fibres of the paper substrate present in the paper substrate according to the invention can be chosen from hardwood pulp, bleached hardwood pulp, softwood pulp, bleached softwood pulp, softwood fluff pulp, hemp fibre, Indian hemp fibre, jute fibre, kenaf fibre, kudzu fibre, coin vine fibre, flax fibre, okra fibre, nettle fibre, papyrus fibre, ramie fibre, sisal fibre, esparto fibre, lyocell fibres (cellulose fibres which are ground and dissolved in N-methylmorpholine N-oxide monohydrate for the purpose of obtaining fibres with a cross section of variable shape (round, oval, cross-shaped, circular, lamellar cross section) with calibrated length and mass per unit length, which the person skilled in the art can choose depending on their needs), viscose fibres (fibres obtained by dissolving cellulose by means of modification of its hydroxyl groups by carbon disulfide (CS₂) and then precipitating it in the presence of sulfuric acid (H₂SO₄) for the purpose of obtaining fibres with a cross section of variable shape (round, oval, cross-shaped, circular, lamellar cross section) with calibrated length and mass per unit length, which the person skilled in the art can choose depending on their needs), and mixtures thereof, in particular hardwood pulp, softwood pulp, and mixtures thereof, more particularly softwood pulp.

The cellulosic fibres of the paper substrate can have a mean length between 1 mm and 3.5 mm, in particular between 1.5 mm and 3 mm, more particularly between 2 mm and 2.7 mm.

The mean length of the cellulosic fibres can be measured via the method ISO 16065-2:2014.

The paper substrate of the present invention can have an air permeability between 0.5 cm³·min⁻¹·cm⁻² and 2000 cm³·min⁻¹·cm⁻², in particular between 10 cm³·min⁻¹·cm⁻² and 1000 cm³·min⁻¹ cm⁻², very particularly between 50 cm³·min⁻¹·cm⁻² and 700 cm³·min⁻¹·cm⁻², and more particularly still greater than 50 cm³·min⁻¹·cm⁻² and less than 500 cm³·min⁻¹·cm⁻².

The air permeability of the paper substrate of the present invention depends on the air permeability of the rough-faced paper substrate used to produce the paper substrate of the present invention.

Therefore, under certain circumstances, the paper substrate of the present invention can have an air permeability from 700 cm³·min⁻¹·cm⁻² to 1500 cm³·min⁻².

Advantageously, the paper substrate having an permeability in the above ranges has a nicotine retention capacity that is even closer to the retention capacity of a cellulose acetate filter, than a filter comprising a conventional paper substrate.

For the purposes of the present application, “air permeability” denotes the mean air flow rate that passes over a unit of surface area of the paper substrate according to the invention under a unit of pressure difference and a unit of time, under specified conditions. The air permeability is determined in accordance with the standard ISO 2965:2009.

The grammage of the paper substrate can, for example, be between 10 g/m² and 60 g/m², in particular between 15 g/m² and 55 g/m², more particularly between 20 g/m² and 50 g/m².

These grammage ranges are those of conventional paper substrates. Thus, the person skilled in the art will know how to easily obtain the paper substrate according to the invention and having such a grammage.

Moreover, these grammage ranges make it possible to easily adapt the paper substrate according to the invention to different filters.

The standard ISO 536:2012 can be used to determine the grammage of the paper substrate. The substrate is conditioned for at least 16 hours at 23° C. and 50% relative humidity before the measurement.

The paper substrate according to the invention can be shaped, in particular it can be crimped, folded or rolled up. This shaping can make it possible to modify the properties of the paper substrate and therefore the properties of the filter comprising it. For example, crimping can make it possible to modify the density of the paper substrate and thus to increase or reduce the pressure drop of the filter comprising the paper substrate according to the invention without changing the weight of the filter. In this way, the shaping of the paper substrate by known processes such as crimping renders it easily adaptable to different filters.

Thanks to its properties, the paper substrate according to the invention can be used in a filter.

According to another aspect, the present invention relates to a filter, in particular a filter for a smoking or vaping article comprising the paper substrate according to the invention as defined above.

In the filter, the paper substrate of the invention is used as the filtration material.

For the purposes of the present application, “smoking article” denotes an article comprising tobacco, any other plant intended to be smoked or mixtures thereof. For example, the smoking article may be a machine-manufactured cigarette, a roll-your-own cigarette or a make-your-own cigarette.

Typically, the filter for a smoking article has a right circular cylindrical shape and comprises an outer envelope of plug wrap paper for a smoking article, in particular for a cigarette, and the paper substrate according to the invention as defined above located within the outer envelope.

For the purposes of the present application, “vaping article” denotes an article comprising tobacco, any other plant intended to be vaped or mixtures thereof, which is intended to be inserted into a device which heats the tobacco, the plant or mixtures thereof without burning said tobacco, plant or mixtures and which enables delivery of an aerosol to a user. For example, the vaping article can be a tobacco stick.

Typically, the filter for a vaping article has a right circular cylindrical shape and comprises an outer envelope of plug wrap paper for a vaping article, in particular for a tobacco stick, and the paper substrate according to the invention as defined above located within the outer envelope.

According to another aspect, the present invention also relates to a smoking article comprising a filter as defined above.

According to another aspect, the present invention also relates to a vaping article comprising a filter as defined above.

The present invention also relates to the use of a paper substrate as defined above in a filter, in particular a filter for a smoking article or a filter for a vaping article.

The present invention also relates to a process for producing a paper substrate according to the invention as defined above, comprising the following steps:
a) producing a rough-faced paper substrate by a wetlaid process,
b) smoothing the rough-faced paper substrate which is produced in step a) to produce the paper substrate,
wherein smoothing step b) is carried out by calendering, flint glazing and combinations thereof, in particular by calendering.

The wetlaid process for producing a paper substrate is a conventional process known to the person skilled in the art. The person skilled in the art will know how to adapt the parameters of this process to produce the paper substrate.

For example, the calendering of smoothing step b) can be carried out with a soft nip calender, with a hard nip calender, with a friction calender, with a supercalender, with a gloss calender, with a hot calender, a cold calender, or combinations thereof.

Smoothing step b) does not alter the grammage of the paper substrate.

The calendering may depend on the calender parameters. Typically, these parameters may be the coating material of the rollers of the calender, the diameter of the rollers of the calender, the normal force per unit length applied by the rollers of the calender to the rough-faced paper substrate, the number of lines of contact of the rollers of the calender with the rough-faced paper substrate, the rotation speed of the rollers of the calender, the temperature of the rollers of the calender, and combinations thereof.

Between step a) and step b), the rough-faced paper substrate may undergo a moistening step in order to obtain a moist paper substrate, this moist paper substrate then being used in step b).

This moistening step is particularly suitable for a step b) that is carried out by calendering.

Advantageously, this moistening step makes it possible to increase the smoothness of the face or faces of the paper substrate obtained by the process according to the invention.

### EXAMPLES

### Example 1: Production of a Paper Substrate According to the Invention

In all the Examples, the smoothness was measured using the “Bekk Smoothness Tester” from Messmer Büchel in accordance with the standard ISO 5627:1995.

The air permeability is determined in accordance with the standard ISO 2965:2009

Example 1.1: Paper Substrate Having a Grammage of 36 q/m²

A rough-faced paper substrate, comprising softwood pulp fibres having a mean length of 2.65 mm and having a grammage of 36 g/m², was produced by a wetlaid process.

This rough-faced paper substrate is divided in three portions.

The first portion of this rough-faced paper substrate was cold calendered using a laboratory soft nip calender (Perkins laboratory calender), by applying a nominal force per unit length of 263 N/mm. Three passes through this calender using this nominal force per unit length were performed.

The physical parameters of the paper substrate having a grammage of 36 g/m² before and after calendering are indicated in Table 1.

### Example 1.2: Paper Substrate Having a Grammage of 36 g/m²

The second portion of the rough-faced paper substrate of Example 1.1 was hot calendered using an industrial hard nip calender. One passes through this calender was performed. The nominal force per unit length was adapted to obtain the paper substrate having the physical parameter presented in Table 1.

The physical parameters of the paper substrate having a grammage of 36 g/m² after calendering are indicated in Table 1.

### Example 1.3: Paper Substrate Having a Grammage of 36 D/M²

The third portion of the rough-faced paper substrate of Example 1.1 was humidified before being hot calendered at 250° C. using a laboratory soft nip calender from Andritz, by applying a nominal force per unit length of 300 N/mm. Two passes through this calender using this nominal force per unit length were performed.

The physical parameters of the paper substrate having a grammage of 36 g/m² after calendering are indicated in Table 1.

### Example 1.4: Paper Substrate Having a Grammage of 36 G/M²

A rough-faced paper substrate, comprising softwood pulp fibres having a mean length of 2.65 mm and having a grammage of 36 g/m², was produced by a wetlaid process.

This rough-faced paper substrate was then hot calendered using an industrial hard nip calender. Two passes through this calender were performed. The nominal force per unit length was adapted to obtain the paper substrate having the physical parameter presented in Table 1.

The physical parameters of the paper substrate having a grammage of 36 g/m² before and after calendering are indicated in Table 1.

### Example 1.5: Paper Substrate Having a Grammage of 50 g/m²

A rough-faced paper substrate, comprising softwood pulp fibres having a mean length of 2.65 mm and having a grammage of 50 g/m², was produced by a wetlaid process.

This rough-faced paper substrate was then cold calendered using a laboratory soft nip calender (Perkins laboratory calender), by applying a nominal force per unit length of 263 N/mm. Three passes through this calender using this nominal force per unit length were performed.

The physical parameters of the paper substrate having a grammage of 50 g/m² before and after calendering are indicated in Table 1 below.

### Example 2: Nicotine Retention Tests on Filters Comprising the Paper Substrates of Example 1 and on a Commercial Cellulose Acetate Filter

Filters for a smoking article were manufactured with the paper substrates of Example 1 by a standard method for manufacturing filters. A nonporous plug wrap paper was used to wrap the rods of filtering material.

The volume is the same for all filters, but the weight of the filters differs. This difference is linked to the calendering, which reduces the filling power of the paper substrates according to the invention. In order to manufacture filters and cigarettes having a pressure drop of the same order of magnitude, it is necessary to use more paper substrate according to the invention, which increases the weight of the filters.

Cigarettes were prepared using the filters described above. To form the cigarettes, the tobacco rods were assembled with the filters using a tipping paper. A commercial “American blend” tobacco was used to form the tobacco rods. The cigarettes were unventilated.

The cigarettes prepared were smoked on a Borgwaldt RM20 smoking machine in accordance with the standard ISO 3308:2000. The pressure drop (“PD” in Table 2) was measured in accordance with the standard ISO 6565:2002.

The retention of a filter is calculated according to the following formula:

Retention (%)=CNWF−CNAF/CNWF×100,
wherein
CNWF is the content of nicotine in the smoke without the filter (in mg), and
CNAF is the content of nicotine in the smoke after the filter (in mg).

The delivery of a filter is the nicotine content in the smoke after the filter.

The nicotine content in the smoke after the filter is determined as follows:

The nicotine content in the smoke produced by 10 smoked cigarettes was measured in accordance with the standard ISO 10315:2000. This nicotine content is then divided by 10 to calculate the nicotine content in the smoke produced by one smoked cigarette.
This measurement is performed 3 times, i.e. with 30 cigarettes, to calculate 3 nicotine contents in the smoke produced by one smoked cigarette.
The nicotine content in the smoke after the filter is the average of these 3 calculated nicotine contents in the smoke produced by one smoked cigarette.

The nicotine content in the smoke without the filter is determined as follows:

A tobacco rod, identical to the tobacco rods used to prepare the cigarettes, was smoked on a Borgwaldt RM20 smoking machine in accordance with the standard ISO 3308:2000. The number of puffs when the tobacco rod is smoked is identical to the number of puffs when the cigarette is smoked. The nicotine content in the smoke produced by 10 smoked tobacco rods was measured in accordance with the standard ISO 10315:2000. This nicotine content is then divided by 10 to calculate the nicotine content in the smoke produced by one smoked tobacco rod.
This measurement is performed 3 times, i.e. with 30 tobacco rods, to calculate 3 nicotine contents in the smoke produced by one smoked tobacco rod.
The nicotine content in the smoke without the filter is the average of these 3 calculated nicotine contents in the smoke produced by one smoked tobacco rod.

The retention and the delivery of each filter comprising the paper substrate of Example 1 is compared to the retention of the commercial cellulose acetate filter.

Table 2 present the “Delta Retention” and the “Delta Delivery” of the filter comprising the paper substrate of Example 1.

The “Delta Retention” value is the difference between the retention of a filter comprising the paper substrate of Example 1 and the retention of the commercial cellulose acetate filter.

The “Delta Delivery” value is calculated according to the following formula:

Delta Delivery (%)=CNAF1−CNACAF/CNACAP×100,
wherein
CNAF1 is the content of nicotine in the smoke after the filter comprising the paper substrate of Example 1 (in mg), and
CNACAF is the content of nicotine in the smoke after the commercial cellulose acetate filter (in mg).

The smoking results are presented in Table 2 below.

As demonstrated by Table 2, for the same grammage:
the nicotine retention of the commercial cellulose acetate filter is closer to the nicotine retention of a filter comprising the paper substrate according to the invention than to the nicotine retention of a filter comprising the rough-faced paper substrate, and
the nicotine delivery of the commercial cellulose acetate filter is closer to the nicotine delivery of a filter comprising the paper substrate according to the invention than to the nicotine delivery of a filter comprising the rough-faced paper substrate.

TABLE 1

| | Example 1.1 | | Example 1.2 | Example 1.3 | Example 1.4 | | Example 1.5 | |
|---|---|---|---|---|---|---|---|---|
| | Paper | Rough-faced | Paper | Paper | Paper | Rough-faced | Paper | Rough-faced |
| | substrate of | paper | substrate of | substrate of | substrate of | paper | substrate of | paper |
| | the invention | substrate | the invention | the invention | the invention | substrate | the invention | substrate |
| Grammage | 36 | 36 | 36 | 36 | 36 | 36 | 50 | 50 |
| (g/m²) | | | | | | | | |
| Smoothness of | 70 s | 1 s | 58 s | 270 s | 158 s | 7 s | 78 s | 1 s |
| the front face | | | | | | | | |
| Smoothness of | 269 s | 1 s | 56 s | 268 s | 358 s | 11 s | 185 s | 3 s |
| the back face | | | | | | | | |
| Permeability | 700 | 3200 | 1245 | 916 | 377 | 1100 | 152 | 978 |
| (cm³ · min⁻¹ · cm⁻²) | | | | | | | | |

TABLE 2

| | | | Weight of the | Pressure drop | Pressure drop of | | |
|---|---|---|---|---|---|---|---|
| | Length of the | Diameter of the | filters with paper | of the filters | the cigarettes | Delta | Delta |
| | filters [mm] | filters [mm] | envelope [mg] | [mmWC] | [mmWC] | Retention | Delivery |
| Commercial cellulose | 21 | 7.8 | 161 | 68 | 107 | / | / |
| acetate filter | | | | | | | |
| Filter comprising the paper | | | 249 | 62 | 109 | 21% | −32% |
| substrate of the invention of | | | | | | | |
| Example 1.1 | | | | | | | |
| Filter comprising the rough- | | | 232 | 70 | 116 | 26% | −41% |
| faced paper substrate of | | | | | | | |
| Example 1.1 | | | | | | | |
| Filter comprising the paper | | | 247 | 65 | 113 | 24% | −36% |
| substrate of the invention of | | | | | | | |
| Example 1.2 | | | | | | | |
| Filter comprising the paper | | | 256 | 57 | 113 | 23% | −34% |
| substrate of the invention of | | | | | | | |
| Example 1.3 | | | | | | | |
| Filter comprising the paper | | | 297 | 75 | 112 | 22% | −32% |
| substrate of the invention of | | | | | | | |
| Example 1.4 | | | | | | | |
| Filter comprising the rough- | | | 253 | 58 | 108 | 28% | −45% |
| faced paper substrate of | | | | | | | |
| Example 1.4 | | | | | | | |
| Filter comprising the paper | | | 253 | 37 | 88 | 12% | −18% |
| substrate of the invention of | | | | | | | |
| Example 1.5 | | | | | | | |
| Filter comprising the rough- | | | 230 | 49 | 90 | 15% | −23% |
| faced paper substrate of | | | | | | | |
| Example 1.5 | | | | | | | |

1. Paper substrate comprising two faces, one of the two faces having a smoothness greater than or equal to 20 s.

2. Paper substrate according to claim 1, wherein both faces have a smoothness greater than or equal to 20 s.

3. Paper substrate according to claim 1, having an air permeability between 0.5 cm³·min⁻¹·cm⁻² and 2000 cm³·min⁻¹·cm⁻².

4. Paper substrate according to claim 1, having a grammage between 10 g/m² and 60 g/m².

5. Paper substrate according to claim 1, wherein the paper substrate comprises cellulosice fibers and wherein the cellulosic fibres thereof are chosen from hardwood pulp, bleached hardwood pulp, softwood pulp, bleached softwood pulp, softwood fluff pulp, hemp fibre, Indian hemp fibre, jute fibre, kenaf fibre, kudzu fibre, coin vine fibre, flax fibre, okra fibre, nettle fibre, papyrus fibre, ramie fibre, sisal fibre, esparto fibre, lyocell fibre, viscose fibre, and mixtures thereof.

6. Paper substrate according to claim 1, wherein the length of the cellulosic fibres thereof is between 1 mm and 3.5 mm.

7. Filter comprising the paper substrate as defined in claim 1 as filtration material.

8. Smoking article comprising a filter as defined in claim 7.

9. Vaping article comprising a filter as defined in claim 7.

10. Process for producing a paper substrate as defined in claim 1, comprising the following steps:
a) producing a rough-faced paper substrate by a wetlaid process,
b) smoothing the rough-faced paper substrate which is produced in step a) to produce the paper substrate,
wherein smoothing step b) is carried out by calendering, flint glazing and combinations thereof.

11. Process according to claim 10, wherein the calendering of smoothing step b) can be carried out with a soft nip calender, with a hard nip calender, with a friction calender, with a supercalender, with a gloss calender, with a hot calender, a cold calender, or combinations thereof.

12. Paper substrate comprising two faces, one of the two faces having a smoothness greater than or equal to 20 s, the paper substrate comprising cellulosic fibers and having an air permeability between 0.5 cm³·min⁻¹·cm⁻² and 2000 cm³·min⁻¹·cm⁻², and having a grammage between 10 g/m² and 60 g/m².

13. Paper substrate according to claim 12, wherein both faces of the paper substrate have a smoothness greater than or equal to 20 s.

14. Paper substrate according to claim 12, wherein the cellulosic fibres thereof are chosen from hardwood pulp, bleached hardwood pulp, softwood pulp, bleached softwood pulp, softwood fluff pulp, hemp fibre, Indian hemp fibre, jute fibre, kenaf fibre, kudzu fibre, coin vine fibre, flax fibre, okra fibre, nettle fibre, papyrus fibre, ramie fibre, sisal fibre, esparto fibre, lyocell fibre, viscose fibre, and mixtures thereof.

15. Paper substrate according to claim 12, wherein the length of the cellulosic fibres thereof is between 1 mm and 3.5 mm.
